(19) United States
(12) Patent Application Publication
(10) Pub. No.: US 2025/0166433 A1
(43) Pub. Date: May 22, 2025

(54) SENSOR DEVICE

(71) Applicant: DENSO CORPORATION, Kariya-city (JP)

(72) Inventors: NAO UEMATSU, Kariya-city (JP); TOSHIHIRO FUJITA, Kariya-city (JP); HIDEKI KABUNE, Kariya-city (JP)

(21) Appl. No.: 19/029,428

(22) Filed: Jan. 17, 2025

Related U.S. Application Data
(63) Continuation of application No. PCT/JP2023/026027, filed on Jul. 14, 2023.

(30) Foreign Application Priority Data
Jul. 21, 2022 (JP) 2022-116582

(51) Int. Cl. G07C 5/08; G01B 7/30; G01D 5/16

(52) U.S. Cl. CPC G07C 5/085; G01B 7/30; G01D 5/16

(57) ABSTRACT

A sensor device has a sensor unit and a controller. The sensor unit operates partially using battery power through a power supply line when the starting switch is off. The sensor device includes a sensing element that detects changes in physical quantities and a determination circuit that identifies power failures when power is not supplied from the power supply line. The sensor unit also has a communication unit that transmits sensor information, including power failure status. The controller, powered through the starting switch, receives this information, transmits return signals to reset power failure information, performs control operations using the sensor data, and stores power failure information in a non-volatile memory.

### CROSS REFERENCE TO RELATED APPLICATIONS

The present application is a continuation application of International Patent Application No. PCT/JP2023/026027 filed on Jul. 14, 2023, which designated the U.S. and claims the benefit of priority from Japanese Patent Application No. 2022-116582 filed on Jul. 21, 2022. The entire disclosures of all of the above applications are incorporated herein by reference.

### TECHNICAL FIELD

The present disclosure relates to a sensor device.

### BACKGROUND

Conventional sensor devices detect an angle of rotation of motors.

### SUMMARY

According to at least one embodiment, a sensor device includes a sensor unit and a controller. The sensor unit continues operating at least partially by being supplied with electric power from a battery through a power supply line while a starting switch is turned off. The sensor device has a sensing element that detects a change in a physical quantity in response to an operation of a detection target. Additionally, the sensor unit has a determination circuit that identifies a power failure when electric power is not supplied from the power supply line, which bypasses the starting switch.

The sensor unit also includes a sensor communication unit that transmits sensor information, including power failure information indicating whether a power failure has occurred. The controller operates by being supplied with electric power through the starting switch.

The controller includes a control communication unit that receives the sensor information from the sensor unit and transmits a return signal to the sensor unit, commanding the sensor unit to reset the power failure information. Furthermore, the controller has a control calculator that performs control operations using the sensor information. The controller also includes a non-volatile memory that stores the power failure information.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a schematic configuration diagram of a steering system according to a first embodiment.

FIG. 2 is a block diagram illustrating a sensor device according to the first embodiment.

FIG. 3 is a flowchart illustrating a transmission process of power failure information according to the first embodiment.

FIG. 4 is a flowchart illustrating a retention process of the power failure information according to the first embodiment.

FIG. 5 is an explanatory diagram illustrating virtual sectors of a non-volatile memory in a second embodiment.

FIG. 6 is a flowchart illustrating a retention process of power failure information according to the second embodiment.

FIG. 7 is an explanatory diagram illustrating a data area of virtual sectors according to a third embodiment.

FIG. 8 is a flowchart illustrating a retention process of power failure information according to the third embodiment.

FIG. 9 is a flowchart illustrating a data out process according to the third embodiment.

FIG. 10 is a flowchart illustrating a retention process of power failure information according to a fourth embodiment.

FIG. 11 is a flowchart illustrating a retention process of power failure information according to a fifth embodiment.

### DETAILED DESCRIPTION

To begin with, examples of relevant techniques will be described.

Conventional sensor devices detect an angle of rotation of motors. A sensor device according to a comparative example is applied to an electric power steering apparatus and is capable of continuing to operate at least in part with power from a battery during periods when an ignition power is turned off.

The sensor device sends a result of determination of the presence or absence of power supply to a controller, and resets a flag when the sensor device receives a return signal sent by the controller after the controller receives the result of the determination. When a reset of the controller occurs after the controller sends the return signal to the sensor device, information indicating the determination result is lost. In contrast to the comparative example, according to a sensor device of the present disclosure, information about a presence or absence of a power supply can be appropriately retained.

According to one aspect of the present disclosure, a sensor device includes a sensor unit and a controller. The sensor unit continues operating at least partially by being supplied with electric power from a battery through a power supply line while a starting switch is turned off. The sensor device has a sensing element that detects a change in a physical quantity in response to an operation of a detection target. Additionally, the sensor unit has a determination circuit that identifies a power failure when electric power is not supplied from the power supply line, which bypasses the starting switch.

The sensor unit also includes a sensor communication unit that transmits sensor information, including power failure information indicating whether a power failure has occurred. The controller operates by being supplied with electric power through the starting switch. The controller includes a control communication unit that receives the sensor information from the sensor unit and transmits a return signal to the sensor unit, commanding the sensor unit to reset the power failure information. Furthermore, the controller has a control calculator that performs control operations using the sensor information. The controller also includes a non-volatile memory that stores the power failure information. According to this configuration, the power failure information can be safely stored.

Hereinafter, a sensor device according to the present disclosure will be described with reference to the drawings. Hereinafter, in a plurality of embodiments, substantially the same components are denoted by the same reference signs, and the description thereof is omitted.

### First Embodiment

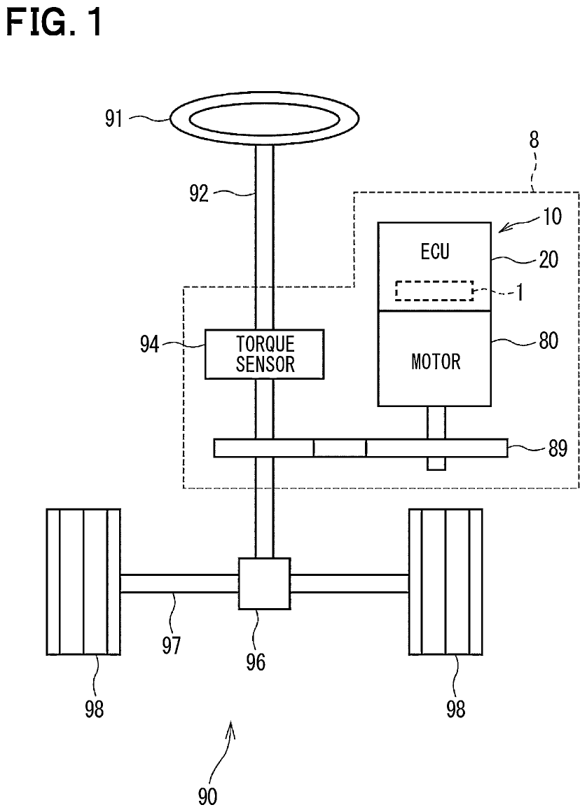

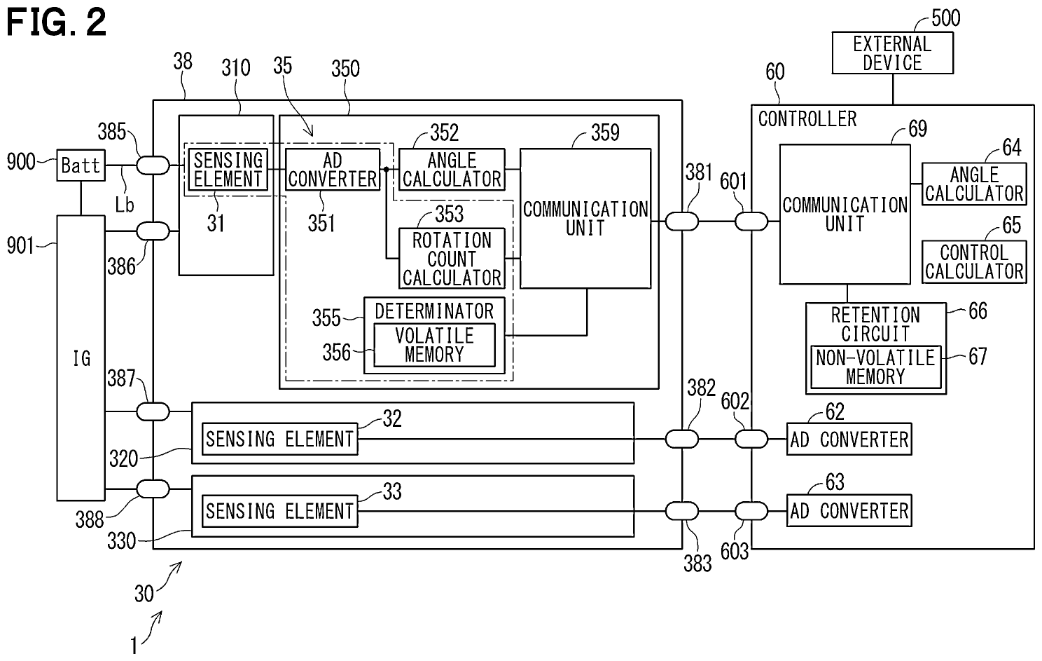

A first embodiment is shown in FIGS. 1 to 4. As shown in FIGS. 1, 2, a sensor device 1 is applied to an electric power steering apparatus 8. FIG. 1 shows a configuration of a steering system 90 including the electric power steering apparatus 8. The steering system 90 includes a steering wheel 91 which is a steering member, a steering shaft 92, a pinion gear 96, a rack shaft 97, wheels 98 and the electric power steering apparatus 8.

The steering wheel 91 is connected to the steering shaft 92. A torque sensor 94 is provided on the steering shaft 92 to detect a steering torque. The pinion gear 96 is provided at an axial end of the steering shaft 92. The pinion gear 96 meshes with the rack shaft 97. A pair of wheels 98 is coupled to both ends of the rack shaft 97 via, for example, tie rods.

When a driver of a vehicle rotates the steering wheel 91, the steering shaft 92 connected to the steering wheel 91 rotates. A rotational movement of the steering shaft 92 is converted to a linear movement of the rack shaft 97 by the pinion gear 96. The pair of wheels 98 is steered to an angle corresponding to a displacement amount of the rack shaft 97.

The electric power steering apparatus 8 includes a drive device 10 having an ECU 20 and a motor 80, a reduction gear 89 which is a power transmission unit that reduces rotation of the motor 80, and transmits the reduced rotation to the steering shaft 92. That is, the electric power steering apparatus 8 of the present embodiment is a column assist type, in which the steering shaft 92 is an object to be driven. The electric power steering apparatus 8 may be a rack assist type, in which the rotation of the motor 80 is transmitted to the rack shaft 97.

The motor 80 outputs part or all of a torque required for steering, and is driven by a power supplied from a battery 900 (see FIG. 2) to rotate the reduction gear 89 forward and backward. The drive device 10 is a so-called “mechanically and electrically integrated type” in which the ECU 20 is provided on one side in an axial direction of the motor 80, but it may be a mechanical and electrically separated type in which the motor and the ECU are separately provided. By adopting the mechanical and electrical integrated type, the ECU 20 and the motor 80 can be efficiently arranged in the vehicle having a limited mounting space. The ECU 20 is provided with the sensor device 1.

As shown in FIG. 2, the sensor device 1 is a rotation detection device that detects rotation of the motor 80, and is equipped with a rotation angle sensor 30 and a controller 60. The rotation angle sensor 30 has sensing elements 31-33 and a signal processor 35. The sensing elements 31, 32, 33 are provided on sensor chips 310, 320, 330, respectively, and the signal processor 35 is provided on a signal processing chip 350. Also, a plurality of sensing elements may be provided on one chip and separated by insulating portions. The sensor chips 310, 320, 330 and the signal processing chip 350 are sealed in a sealing portion 38.

The sensing elements 31-33 are, for example, magnetic resistance elements such as an AMR sensor, a TMR sensor, a GMR sensor, or Hall elements, and detect a magnetic field of a sensor magnet (not shown) that rotates integrally with the shaft of the motor 80, and output a set of sine and cosine signals, which are analog signals. The sensing elements 31-33 may be the same or may have different amplitudes of detection signals or the like. Furthermore, the sensing element 31 may have different performances, for example, the sensing element 31 may have higher detection accuracy than the sensing elements 32, 33. When different types of elements are used for at least some of the sensing elements 31-33, failure modes are different, so probability of simultaneous failure can be reduced.

The signal processor 35 has an AD converter 351, an angle calculator 352, a rotation count calculator 353, a determinator 355, and a communication unit 359. The AD converter 351 converts the sine signal and the cosine signal output from the sensing element 31 into digital signals.

The angle calculator 352 uses the digitally converted detection value of the sensing element 31 to calculate a motor rotation angle θm1. The rotation count calculator 353 uses the detection value of the sensing element 31 that has been digitally converted by the AD converter 351 to calculate the number of rotations TC of the motor 80. The number of rotations TC can be calculated based on a count value, for example, by dividing one rotation of the motor 80 into three or more regions and counting up or down according to a rotation direction each time the region changes.

The determinator 355 has a volatile memory 356 and determines a power failure that disrupts a direct power supply from the battery 900 via a power supply terminal 385. The volatile memory 356 serves as a power failure flag. In other words, when a normal value of the power failure flag is “1”, no power failure is considered to have occurred and the power failure flag is not set. On the other hand, when the power failure occurs, the volatile memory 356 is reset to an initial value of “0”, and the power failure flag is considered to be set.

The communication unit 359 is configured with a serial interface and transmits digital signals including information pertaining to the motor rotation angle θm1 and the rotation count TC to the controller 60. The motor rotation angle θm1 and the rotation number TC are used by the controller 60 for various control calculations. The communication unit 359 also transmits a power failure determination result to the controller 60. In detail, when the volatile memory 356 has the initial value of “0”, “0” is transmitted as bit information corresponding to the power failure determination result. When the volatile memory 356 has the normal value of “1”, “1” is transmitted as the bit information corresponding to the power failure determination result. In the present embodiment, a 2-bit area is used as the power failure determination result to prevent bit corruption and to prevent erroneous determination. The controller 60 considers that the power failure flag is set when both of the two bits are “0”.

The communication unit 359 also receives a return signal from the controller 60. The return signal is a signal that commands the volatile memory 356 to return from an initial value of “0” to a normal value of “1” and can also be viewed as a signal to reset the power failure flag. In other words, the rotation angle sensor 30 holds power failure information until it receives the return signal from the controller 60, and when the return signal is received, the power failure information is reset.

The sealing portion 38 is provided with output terminals 381 to 383 and power supply terminals 385 to 388. An output terminal 381 is connected to a terminal 601 of the controller 60 and is used to output a digital signal including a value calculated using the detection value of the sensing element 31. An output terminal 382 is connected to a terminal 602 of the controller 60 and is used to output an analog signal according to the detection value of the sensing element 32. An output terminal 383 is connected to a terminal 603 of the controller 60 and is used to output an analog signal according to the detection value of the sensing element 33. In other words, the rotation angle sensor 30 of the present embodiment has a mixed digital-analog configuration.

In FIG. 2, each output terminal 381 to 383 and each communication line are provided one for each system, but a plurality of output terminals 381 to 383 and communication lines may be provided for at least some systems depending on a communication system and data system. Furthermore, an amplifier circuit and a filter circuit may be provided as appropriate. In addition, by providing NC (Non Connection) terminals among the terminals 601 to 603, it is possible to prevent a plurality of signals from becoming abnormal due to a common cause failure such as a short circuit between adjacent terminals caused by a foreign substance.

The power supply terminal 385 is connected to the battery 900. A battery feed line Lb, which is a power supply line, connects the battery 900 with the power supply terminal 385 without going through a starting switch 901 (hereinafter referred to as “IG”), which is a vehicle's ignition switch. The power supply terminals 386 to 388 are connected to the battery 900 via the starting switch 901. The power supply terminals 385 to 388 may be supplied with boosted or bucked electric power from the battery 900 or the starting switch 901.

The power supply terminals 385, 386 are connected to the sensor chip 310 and the signal processing chip 350. The detection element 31, the AD converter 351, the rotation count calculator 353 and the determinator 355, which are enclosed by a dash-dot-dash line in FIG. 2, are constantly supplied with power via the power supply terminal 385 even when the IG is off. As a result, the calculation of the number of rotations TC continues even while the IG is off.

Furthermore, when the IG is off, no power is supplied to the angle calculator 352 and the communication unit 359, and the processing stops. The power supply terminal 387 is connected to the sensor chip 320, and the power supply terminal 388 is connected to the sensor chip 330. That is, in the present embodiment, the power supply terminals 385 to 388 are provided for each of the sensing elements 31 to 33, and the power supply terminals 385 to 388 are configured not to interfere with each other. Furthermore, the sensing elements 31 to 33 are configured to ensure an insulating property between the sensing elements.

The controller 60 is mainly composed of a microcomputer and the like, and internally includes, although not shown in the figure, a central processing device (i.e., CPU), a read only memory (i.e., ROM), a random access memory (i.e., RAM), an input-output (i.e., I/O), a bus line for connecting these components, and the like. Each process executed by the controller 60 may be a software process or may be a hardware process. The software process may be implemented by causing the CPU to execute a program. The program may be stored beforehand in a memory device such as a ROM, that is, in a computer-readable, non-transitory, tangible storage medium. The hardware process may be implemented by a special purpose electronic circuit.

The controller 60 has AD converters 62, 63, an angle calculator 64, a control calculator 65, a power failure information retention circuit 66, and a communication unit 69. The AD converters 62, 63 convert analog signals output from the sensing elements 32, 33 into digital signals. In the present embodiment, the AD converters 62, 63 are provided on the controller 60, and the detection signals of the sensing elements 32, 33 are output to the controller 60 as analog signals without being digitally converted. In other words, in the rotation angle sensor 30, the configuration related to the signal processing of the sensing elements 32, 33 is omitted, and the configuration of the rotation angle sensor 30 is simplified.

The angle calculator 64 calculates motor rotation angles θm2, θm3 based on signals from the rotation angle sensor 30. In detail, the angle calculator 64 calculates a motor rotation angle θm2 using a digitally converted detection value of the sensing element 32, and calculates a motor rotation angle θm3 using a digitally converted detection value of the sensing element 33. Hereafter, when the distinction between sensing elements 31 to 33 is unnecessary, the motor rotation angle θm is simply used.

The angle calculator 64 calculates an absolute angle θa, which is an amount of rotation from a reference position, based on the motor rotation angle Om and the number of rotations TC. The absolute angle θa is a value that can be converted into the steering angle θs using a gear ratio or the like. In the present embodiment, the angle calculator 64 performs an abnormality determination by comparing the motor rotation angles θm1 to θm3 based on signals from the three sensing elements 31 to 33, and performs absolute angle calculation using values that are normal.

The angle calculator 64 calculates the absolute angle θa using the motor rotation angle θm and the number of rotations TC in the first calculation, and in the second and subsequent calculations, the absolute angle θa is calculated by differential integration of the motor rotation angle θm. The absolute angle θa may be calculated using the number of rotations TC each time, or the number of rotations TC may be used at a predetermined frequency to detect software errors and correct errors.

In the present embodiment, the calculation of the number of rotations TC is continued during a period when the IG is turned off. Thereby, even if the motor 80 is rotated by steering the steering wheel 91 while the IG is turned off, the steering angle θs can be calculated without relearning the reference position. Since the value when the IG is on may be used as the motor rotation angle θm, there is no need to continue calculation by constant power supply.

The control calculator 65 performs various calculations related to drive control of the motor 80. The power failure information retention circuit 66 has a non-volatile memory 67. The non-volatile memory 67 stores the power failure information, which is information on whether a power failure has occurred in the rotation angle sensor 30. The communication unit 69 receives sensor information including the power failure information from the rotation angle sensor 30 and transmits return information to the rotation angle sensor 30. In addition, in order to avoid complication, some control lines are omitted in FIG. 2.

The controller 60 is not powered during IG off and stops processing. When the IG is turned on, the controller 60 is capable of resetting the power failure information of the rotation angle sensor 30 by acquiring the power failure information from the rotation angle sensor 30 and sending the return signal to the rotation angle sensor 30 after acquiring the power failure information.

For example, if the battery voltage drops due to high current flowing to a starter during engine start, such as when a battery life is nearing the end of its life, the controller 60 may not be able to operate and a reset may occur. If the controller 60 is reset after the return signal is sent, there is a risk that a history of the power failure will remain neither on the rotation angle sensor 30 nor on the controller 60. Therefore, in the present embodiment, the power failure information is stored in the non-volatile memory 67 before sending the return signal. When a power failure has occurred, the controller 60 notifies other devices (for example, high-level ECUs) of this information.

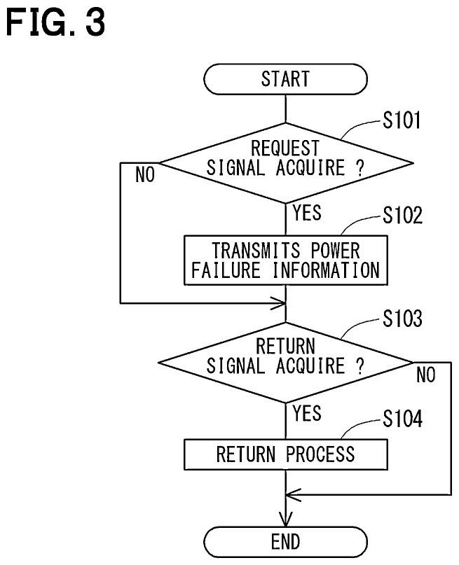

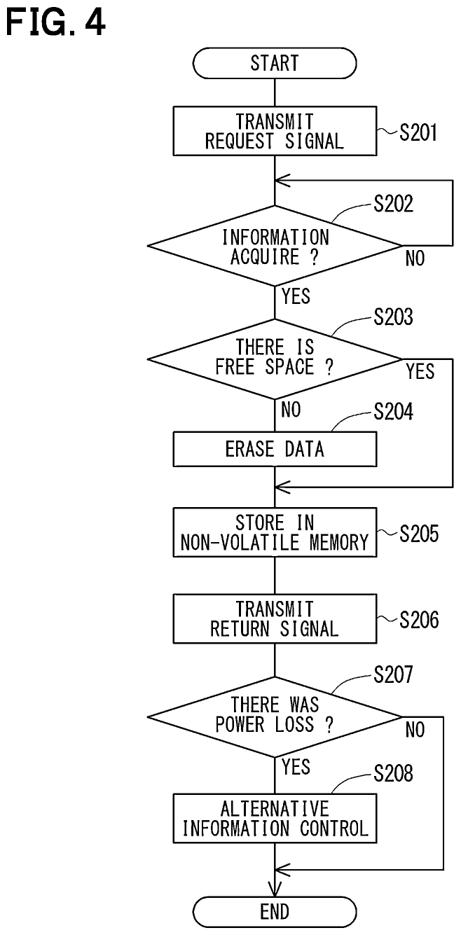

A transmission process of the power failure information and a retention process of the power failure information of the present embodiment are explained based on flowcharts in FIGS. 3, 4, respectively. The transmission process shown in FIG. 3 is executed at a predetermined cycle by the signal processor 35 of the rotation angle sensor 30. Hereinafter, “step” may be simply referred to as a symbol “S.”

In S101, the signal processor 35 determines whether it has acquired the request signal transmitted from the controller 60. When it is determined that the request signal has not been acquired (S101: NO), the process proceeds to S103. When it is determined that the request signal is acquired (S101: YES), the process proceeds to S102 and transmits the power failure information to the controller 60.

In S103, the signal processor 35 determines whether it has acquired the return signal transmitted from the controller 60. When it is determined that the return signal has not been acquired (S103: NO), the process in S104 is skipped. When it is determined that the return signal is acquired (S103: YES), the process proceeds to S104 and the return process is performed. More specifically, the volatile memory 356 is restored to the normal value of “1”.

The retention process shown in FIG. 4 is executed by the controller 60 when the IG is turned on. In S201, the controller 60 sends the request signal to the rotation angle sensor 30 requesting the power failure information.

In S202, the controller 60 determines whether the power failure information from the rotation angle sensor 30 has been acquired. When it is determined that the power failure information has not been acquired (S202: NO), this process is repeated. When it is determined that power failure information has been acquired (S202: YES), the process proceeds to S203.

In S203, the controller 60 determines whether there is free space in the non-volatile memory 67. When it is determined that there is no free area (S203: NO), the process proceeds to S204 to erase data in a write area of the non-volatile memory 67. When it is determined that there is free space (S203: YES), the process skips S204 and proceeds to S205.

In S205, the controller 60 stores the power failure information obtained from the rotation angle sensor 30 in the non-volatile memory 67. In S206, the controller 60 sends the return signal to the rotation angle sensor 30.

In S207, the controller 60 determines whether there was a power loss of the rotation angle sensor 30 during IG off. When it is determined that there was no power failure during IG off (S207: NO), the process of S208 is skipped. When it is determined that there was the power failure during IG off (S207: YES), the process proceeds to S208.

In S208, the controller 60 acquires alternative information from an external device 500 that can calculate the number of rotations TC, and controls using the alternative information. In the present embodiment, the external device 500 is, for example, a steering sensor, and steering angle information based on detected values of the steering sensor or the like is acquired as the alternative information. The angle calculator 64 calculates the absolute angle θa using the alternative information. In addition, a correction processing is performed to adjust the reference value when the vehicle is moving straight ahead, and the correction information is stored in the non-volatile memory 67 as information pertaining to alternative information control.

In the present embodiment, when the IG is turned on, the controller 60 stores the power failure information obtained from the rotation angle sensor 30 in the non-volatile memory 67 and then sends the return signal to the rotation angle sensor 30. As a result, even if a reset of the controller 60 occurs due to a drop in the battery voltage, for example due to cranking, the history of the power loss is maintained in the rotation angle sensor 30 or in the non-volatile memory 67.

As described above, the sensor device 1 includes the rotation angle sensor 30 and the controller 60. The rotation angle sensor 30 has the sensing elements 31 to 33, the determinator 355, and the communication unit 359, and is capable of continuing to operate at least partially by receiving the power supply from the battery feed line Lb even while the starting switch 901 is turned off.

The sensing elements 31 to 33 detect changes in physical quantities in response to the operation of the motor 80, which is a detection target. The determinator 355 is capable of determining a power failure in which the electric power is no longer supplied from the battery feed line Lb not via the starting switch 901. The communication unit 359 transmits the sensor information including the power failure information pertaining to whether the power failure has occurred. In addition to the power failure information, the sensor information includes the rotation angle information, the rotation frequency information, and the abnormality information of the rotation angle sensor 30.

The controller 60 includes the communication unit 69, the control calculator 65, and the non-volatile memory 67, and operates with power supplied via the starting switch 901. In other words, the controller 60 is inactive while the starting switch 901 is off. The information stored in the non-volatile memory 67 is retained even after the starting switch 901 is turned off.

The communication unit 69 receives the sensor information from the rotation angle sensor 30 and sends the return signal to the rotation angle sensor 30 that commands the reset of the power failure information. The control calculator 65 performs control and calculation using the sensor information. The non-volatile memory 67 stores the power failure information. The controller 60 obtains the power failure information from the rotation angle sensor 30 while the starting switch 901 was off, stores the power failure information in the non-volatile memory 67, and then sends the return signal to the rotation angle sensor 30. The power failure information to be stored in the non-volatile memory 67, for example, a data format, etc., may be different from that transmitted from the rotation angle sensor 30.

As a result, at least one of the rotation angle sensor 30 and the non-volatile memory 67 to retain historical information pertaining to power failure history, even if the controller 60 is reset immediately after the starting switch 901 is turned on due to a voltage drop caused by cranking, for example.

When a power failure occurs while the starting switch 901 is turned off at the rotation angle sensor 30, the control calculator 65 performs alternative information control using the alternative information obtained from the external device 500 other than the rotation angle sensor 30. The non-volatile memory 67 stores information pertaining to the alternative information control. As a result, the proper control is performed even if the power loss occurs while the starting switch 901 is off.

### Second Embodiment

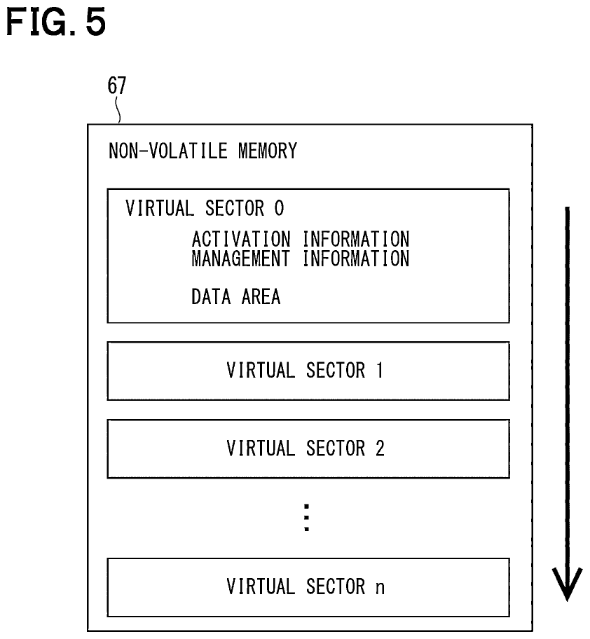

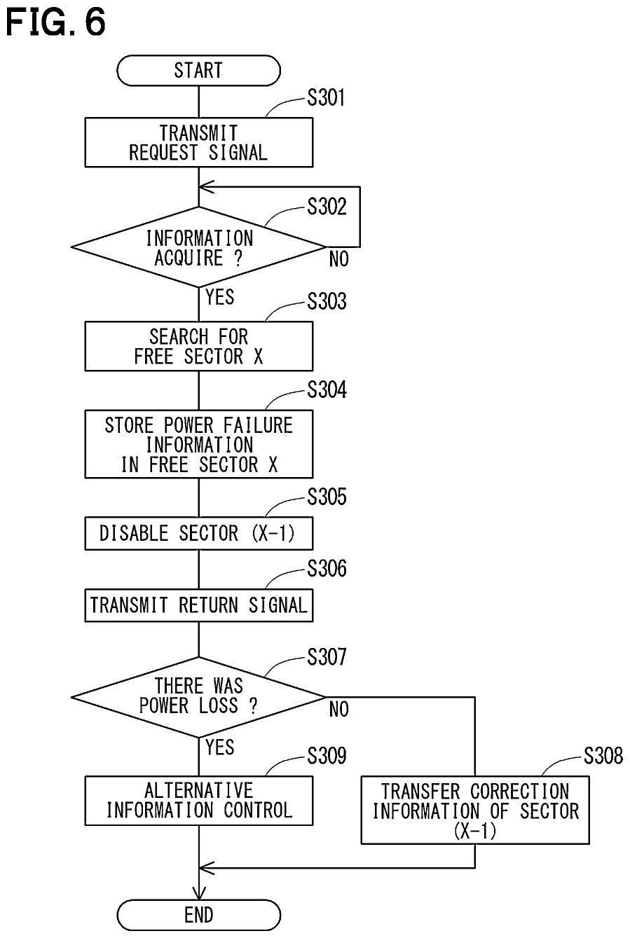

A second embodiment is illustrated in FIGS. 5, 6. As explained in the above embodiment, a controller 60 sends a return signal to a rotation angle sensor 30 after storing power failure information in a non-volatile memory 67, so that the power failure information is retained even when a reset of the controller 60 occurs.

When the non-volatile memory 67 is, for example, EEPROM or flash memory, data is generally written after the write area has been erased, but if it takes time to erase the area, it may not be possible to write the power failure information during a time from IG ON until the starter starts (about 0.6 seconds).

As shown in FIG. 5, the non-volatile memory 67 of the present embodiment has virtual sectors 0 to n. Each virtual sector has a data area used to store activation information indicating whether sector's information is valid or invalid, management information for stored data, and the power failure information. When storing the power failure information, as indicated by an arrow, the information is used starting from virtual sector 0, and when it is used up to virtual sector n, the information in at least some sectors other than the sector where the latest information is stored (for example, the last virtual sector n) is erased. Data erasure can be performed at any timing, but it is preferable to perform the data erasure at a timing with sufficient time and computing load, for example, when garbage collection is performed in an IG-OFF sequence.

A retention processing of the present embodiment is described based on a flowchart in FIG. 6. Processes of S301, S302 are similar to the processes of S201, S202 in FIG. 4. When it is determined that power failure information has been acquired (S302: YES), the process proceeds to S303.

In S303, the controller 60 searches for a free sector X in the non-volatile memory 67. Here, the search is performed sequentially starting from virtual sector 0, and a first free area is designated as a free sector X. In S304, the controller 60 stores information pertaining to the presence or absence of power failure in the free sector X, and in S305, the controller 60 disables the sector (X−1) immediately before the current free sector X. In S306, the controller 60 sends the return signal to the rotation angle sensor 30, as in S206 in FIG. 4.

In S307, the controller 60 determines whether there was a power failure of the rotation angle sensor 30 during IG off, as in S207 in FIG. 4. When it is determined that there was no power failure (S307: NO), the process proceeds to S308, and when there is correction information stored in the immediately preceding sector (X−1), the correction information is transferred to the free sector X to ensure information continuity. When it is determined that there has been a power failure (S307: YES), the process proceeds to S309 and performs the alternative information control as in S208 in FIG. 4. In addition, the correction information is also stored in sector X where the power failure history is stored.

In the present embodiment, the virtual sectors 0 to n are provided in the non-volatile memory 67 to store the power failure information, and a free area that can store the power failure information is reserved at the timing when the power failure information is acquired from the rotation angle sensor 30 at the time of IG ON. As a result, a time required for data writing can be reduced.

Sectors in which information other than the latest is stored are disabled using flags, and the angle calculator 64 and the control calculator 65 may use information in the sectors that are valid. As a result, appropriate information can be used without having to clear data each time.

In the present embodiment, the virtual sectors 0 to n are provided in the non-volatile memory 67. The controller 60 stores the power failure information in a free virtual sector and determines valid data by controlling the activation information. As a result, a time span required to write the power failure information can be reduced compared to a case where data in the write area is erased before writing.

During a period until the starting switch 901 is turned off, the controller 60 erases data in at least one virtual sector, except where valid data is stored. The processing during the period until the starting switch 901 is turned off may include the IG-OFF sequence, which is an operation when the power is turned off. As a result, a free space can be secured in an area where the power failure information is to be stored when the starting switch 901 is turned on. In addition, the same effects as those of the above embodiments are exerted.

### Third Embodiment

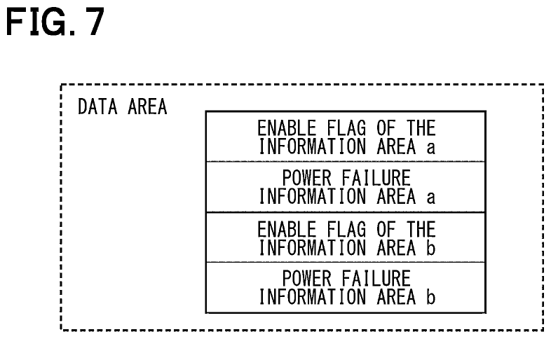

A third embodiment is shown in FIGS. 7 to 9. As shown in FIG. 7, in the present embodiment, a data area of at least one virtual sector of a non-volatile memory 67 has multiple (two in an example in FIG. 7) information areas a, b for power failure information. An information area a is described as having priority among the information areas a, b when using such the virtual sector.

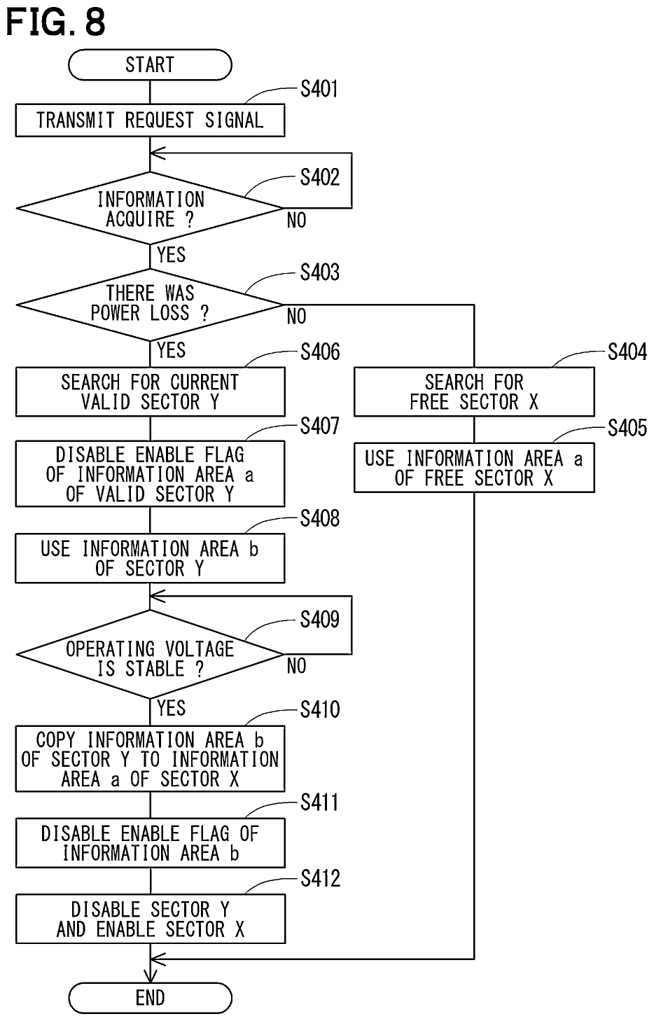

A retention processing of the present embodiment is described based on a flowchart in FIG. 8. Processes of S401, S402 are similar to the processes of S201, S202 in FIG. 4. In S403, which is shifted to when it is determined that the power failure information has been acquired (S402: YES), the controller 60 determines whether there was a power failure of the rotation angle sensor 30 during IG off, as in S207 in FIG. 4. When it is determined that there has been a power failure (S403: YES), the process proceeds to S406. When it is determined that there was no power failure (S403: NO), the process proceeds to S404.

The controller 60 searches for a free sector X in S404, and stores the power failure information acquired this time, which is there is no power failure history, in the information area a of the free sector X in S405.

In S406, the controller 60 searches for a current valid sector Y. In the valid sector Y, the power failure information is stored in the information area a. In S407, the controller 60 disables an enable flag of the information area a of the valid sector Y. In S408, the controller 60 stores information pertaining to the power failure acquired this time and correction information pertaining to alternative control in the information area b of the valid sector Y.

In S409, the controller 60 determines whether an operating voltage is stable. Here, a voltage value itself, such as battery voltage, may be monitored, or, for example, when a time span required for cranking has elapsed, the operating voltage may be determined to be stable. When it is determined that the operating voltage is not stable (S409: NO), the determination process is repeated. When the operating voltage is determined to be stable (S409: YES), the process proceeds to S410.

In S410, the controller 60 copies information in the information area b of the currently active sector Y to the information area a of the free sector X. In S411, the controller 60 disables an enable flag of the information area b of the currently enabled sector Y. In S412, the controller 60 disables the currently enabled sector Y and enables the sector X from which the information was copied.

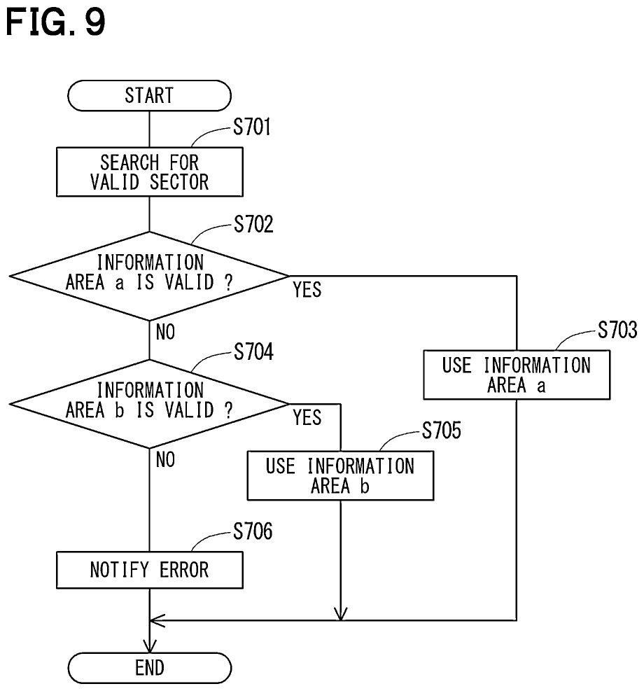

An information readout process is explained based on a flowchart in FIG. 9. In S701, the controller 60 searches for the valid sector in the non-volatile memory 67. In S702, the controller 60 determines whether the information area a of the searched valid sector is valid. When it is determined that information area a is valid (S702: YES), the process proceeds to S703, and the information in information area a is used for various controls. When the information area a is determined to be invalid (S702: NO), the process proceeds to S704.

In S704, the controller 60 determines whether the information area b is valid. When it is determined that information area b is valid (S704: YES), the process proceeds to S705, and the information in information area b is used for various controls. When the information area b is determined to be invalid (S704: NO), the process proceeds to S706. In S706, the controller 60 notifies an error because there is no valid data.

In the present embodiment, each virtual sector of the non-volatile memory 67 is configured to allow multiple writes of the enable flag and the power failure information. As a result, information can be safely stored without the need for data erasure at the time the power failure information is acquired. In addition, the same effects as those of the above embodiments are exerted.

### Fourth Embodiment

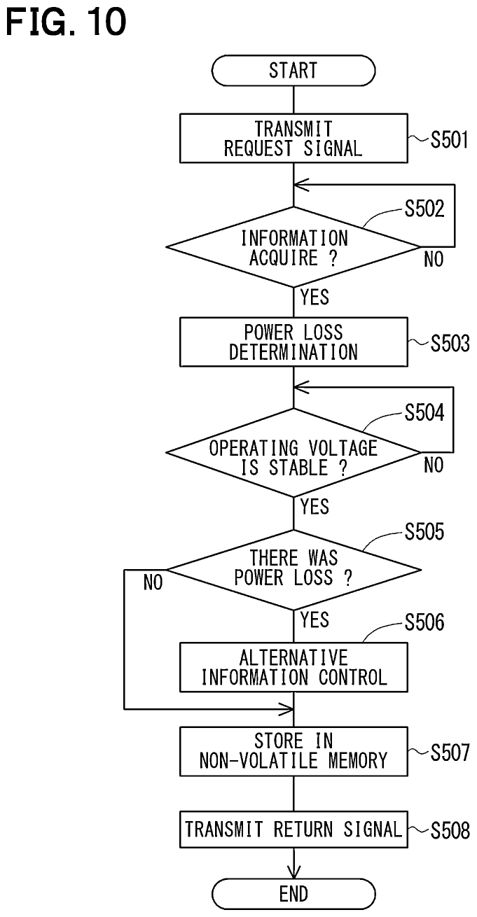

A retention processing of a fourth embodiment is described based on a flowchart in FIG. 10. In the present embodiment, storage of power failure information and transmission of a return signal are performed by avoiding a timing of cranking, which may cause a reset due to a voltage drop.

Processes of S501, S502 are similar to the processes of S201, S202 in FIG. 4. In S503, the controller 60 determines whether there is a power loss during IG off. A process of S504 is similar to the process of S409 in FIG. 8, where the controller 60 determines whether the operating voltage is stable. When it is determined that the operating voltage is not stable (S504: NO), the determination process is repeated. When the operating voltage is determined to be stable (S504: YES), the process proceeds to S505.

A process of S505 is the same as the process of S207 in FIG. 4. When it is determined that there was no power loss (S505: NO), the process proceeds to S507, and when it is determined that there was a power loss (S505: YES), the process proceeds to S506 to perform alternative information control. As the alternative information control, the absolute angle calculation using external information and correction processing to align the reference position when the vehicle is moving straight ahead are performed, as in S208 in FIG. 4.

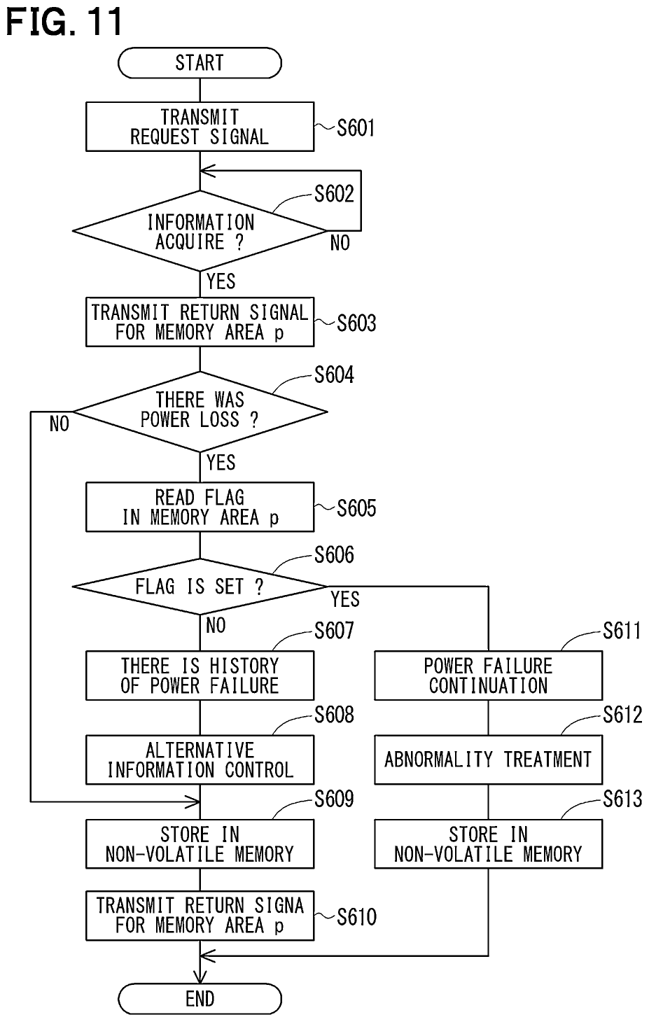

In S507, the controller 60 stores information pertaining to the alternative information control, such as the power failure information and correction values in case of power failure, in the non-volatile memory 67. Any method of storing the data in the non-volatile memory 67 can be used, for example, the method of the second and third embodiments. This also applies to S609 in FIG. 11.

In S508, the controller 60 sends the return signal to the rotation angle sensor 30. In FIG. 8, after the cranking is completed, the return signal is transmitted continuously and stored in non-volatile memory. However, the return signal may be transmitted at any timing after the cranking is completed, for example, in an IG-off sequence with time to spare.

After a voltage drop period due to driving other devices that share the battery 900 is completed, the controller 60 stores the power failure information in the non-volatile memory 67 and then sends the return signal to the rotation angle sensor 30. During the voltage drop period, a determination is made as to whether the power failure has occurred. As a result, the rotation angle sensor 30 retains the power failure information even when the controller 60 is reset due to a drop in the battery voltage, for example, due to cranking.

The communication unit 69 may send the return signal to the rotation angle sensor 30 in a power off operation process when the starting switch 901 is turned off. The same is true for the return signal transmission in the above embodiments. As a result, a computational load can be reduced immediately after the starting switch 901 is turned on, which is a relatively large computational load. In addition, the same effects as those of the above embodiments are exerted.

### Fifth Embodiment

A retention processing of a fifth embodiment is described based on a flowchart in FIG. 11. In the present embodiment, a volatile memory 356 of a rotation angle sensor 30 has memory areas p, q. The memory areas p, q are flagged with an initial value of “0” at the same time in an event of a power failure. A normal value “1” is set when resetting a power failure flag. The reset can be performed separately for each memory area p, q. The memory areas p, q are one each, but there may be more than one, and the number of areas may differ each other.

Processes of S601, S602 are similar to the processes of S201, S202 in FIG. 4. In S603, which moves to when it is determined that the power failure information has been acquired (S602: YES), the controller 60 sends the return signal for the memory area p. As a result, in the rotation angle sensor 30, the memory area p returns to the normal value “1” when the power failure has been resolved.

On the other hand, when the power failure continues due to disconnection of the battery feed line Lb or other reasons, the memory area p maintains the initial value “0”. Even if the power failure continues, the rotation angle sensor 30 can be operated if electric power is supplied via the IG by turning on the IG. At this stage, a restoration process pertaining to the memory area q is not performed, and when the power failure occurs during IG off and the initial value is “0”, the state is maintained.

In S604, the controller 60 determines whether there was a power loss of the rotation angle sensor 30 during IG off. When it is determined that there was no power failure during IG off (S604: NO), the process proceeds to S609 and stores information pertaining to the presence or absence of the power failure in the non-volatile memory 67. When it is determined that there was the power failure during IG off (S604: YES), the process proceeds to S605.

In S605, the controller 60 reads the power failure flag in the memory area p from the rotation angle sensor 30. In S606, the controller 60 determines whether the power failure flag in the memory area p is set. In case it is determined that the power failure flag has been set (S606: YES), the process proceeds to S611. In case it is determined that the power failure flag is not set (S606: NO), the process proceeds to S607.

In S607, since the power failure flag in the memory area p is reset by the transmission of the return signal, the controller 60 determines that there is a history of the power failure during IG off in the rotation angle sensor 30 and that the power failure has been resolved.

The controller 60 performs alternative information control in S608 and stores information pertaining to the presence or absence of the power failure and information such as correction values in case of the power failure in the non-volatile memory 67 in S609. In S610, the controller 60 sends the return signal for the memory area q. A timing for sending the return signal to the memory area q can be performed at any time after data has been stored in the non-volatile memory 67.

In S611, which is shifted to when the power failure flag in the memory area p is set even after the return signal is sent (S606: YES), the controller 60 determines that the power failure continues in the rotation angle sensor 30. The controller 60 performs abnormality treatment in S612 and then stores abnormality information indicating that the power failure to the rotation angle sensor 30 is continuing in the non-volatile memory 67 in S613.

In the present embodiment, after sending the return signal, the controller 60 reacquires the power failure information from the rotation angle sensor 30 and determines whether the power failure continues at the rotation angle sensor 30 based on the reacquired power failure information. When the power failure flag is not reset even after the return signal is sent, it can be confirmed that the power failure condition continues.

A determinator 355 has a volatile memory 356 with multiple storage areas for storing the power failure information. The multiple storage areas simultaneously store information that the power failure has been reported when the power failure occurs. A term “simultaneous” shall allow for a time gap to the extent that it is possible to remember that the power failure has occurred. The multiple memory areas can be reset at different times for each area in response to the return signal.

The controller 60 also sends the return signal for some storage areas before storing the power failure information in the non-volatile memory 67. As a result, the presence or absence of the power loss of the rotation angle sensor 30 during IG off can be determined. Even if the controller 60 is reset by a voltage drop due to cranking before the power failure information is stored in the non-volatile memory 67, the power failure information is retained in the memory area q, so that information relating to the power failure when the IG is off can be properly acquired by acquiring the power failure information again after the controller 60 is reset.

By checking the power failure flag of the memory area p to which the return signal was sent before the power failure information is stored in the non-volatile memory 67, it is possible to quickly determine whether the power failure continues at the rotation angle sensor 30. In addition, the same effects as those of the above embodiments are exerted.

In the embodiment, the rotation angle sensor 30 corresponds to a “sensor unit,” the angle calculator 352 and rotation count calculator 353 correspond to a “sensor information calculator,” the volatile memory 356 corresponds to a “memory,” the communication unit 359 corresponds to a “sensor communication unit,” the communication unit 69 corresponds to a “control communication unit,” and the motor 80 corresponds to a “control object”. In addition, the correction information corresponds to “information relating to the alternative information control”.

### Other Embodiments

In the above embodiment, one control unit is provided for one rotation angle sensor, and the configuration is a mixed analog-digital configuration. In other embodiments, there may be multiple combinations of rotation angle sensors and control units, a detection value of one rotation angle sensor may be shared by multiple control units, or multiple rotation angle sensors may be provided for a single control unit. A communication between the rotation angle sensor and the control unit is not limited to mixed analog-digital communication, but may be digital communication only.

In the above embodiments, the sensor device detects the rotation of the motor. In other embodiments, the sensor device may be something other than a motor rotation angle sensor, such as a torque sensor or a steering sensor.

In the above-described embodiments, the motor is a three-phase brushless motor. In other embodiments, the motor is not limited to the three-phase brushless motor, and any motor may be used. Further, the motor may also be a motor generator, or may be a motor-generator having both of a motor function and a generator function, i.e., not necessarily be limited to the rotating electric machine. In the above embodiment, the sensor device is applied to the electric power steering apparatus. In one or more other embodiments, the sensor device may be applied to other apparatuses different from the electric power steering apparatus.

The controller and the method according to the present disclosure may be implemented by a dedicated computer provided by constituting a processor and a memory programmed to execute one or more functions embodied by a computer program. Alternatively, the controller described in the present disclosure and the method thereof may be implemented by a dedicated computer configured as a processor with one or more dedicated hardware logic circuits. Alternatively, the controller and method described in the present disclosure may be implemented using one or more dedicated computers, which include a combination of a processor consisting of one or more hardware logic circuits, and a processor and memory programmed to perform one or more functions. The computer programs may be stored, as instructions to be executed by a computer, in a tangible non-transitory computer-readable medium. The present disclosure is not limited to the above embodiments but various modifications may be made further within the scope of the present disclosure without departing from the spirit of the disclosure.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A sensor device comprising:
a sensor unit configured to continue operating at least partially by being supplied with electric power from a battery though a power supply line while a starting switch is turned off, and including
a sensing element configured to detect a change in a physical quantity in response to an operation of a detection target,
a determination circuit configured to determine a power failure in which electric power is not supplied from the power supply line, which goes without through the starting switch, and
a sensor communication unit configured to transmit sensor information including power failure information on whether the power failure has occurred; and
a controller configured to operate by being supplied with the electric power through the starting switch, and including
a control communication unit configured to receive the sensor information from the sensor unit and to transmit a return signal to the sensor unit commanding the sensor unit to reset the power failure information,
a control calculator configured to perform a control operation using the sensor information, and
a non-volatile memory configured to store the power failure information, wherein
the controller is configured to obtain the power failure information from the sensor unit while the starting switch is off, store the power failure information in the non-volatile memory, and then transmit the return signal to the sensor unit.

2. The sensor device according to claim 1, wherein
the control calculator is configured to perform alternative information control using alternative information acquired from an external device other than the sensor unit when the power failure in the sensor unit occurs while the starting switch is turned off, and
the controller is configured to store information relating to the alternative information control in the non-volatile memory.

3. The sensor device according to claim 1, wherein
the controller is configured to store the power failure information in the non-volatile memory after a voltage drop period due to driving other devices sharing the battery is completed.

4. The sensor device according to claim 1, wherein
the control communication unit is configured to transmit the return signal to the sensor unit during a process of turning off the starting switch.

5. The sensor device according to claim 1, wherein
the non-volatile memory has virtual sectors, and
the controller is configured to store the power failure information in a vacant virtual sector in the virtual sectors and determine valid data by controlling enabling information.

6. The sensor device according to claim 5, wherein
the controller is configured to erase data in at least one virtual sector other than a sector in which valid data is stored during a period until the starting switch is turned off.

7. The sensor device according to claim 1, wherein
the controller is configured to reacquire the power failure information from the sensor unit after transmitting the return signal, and to determine whether the power failure continues at the sensor unit based on the reacquired power failure information.

8. The sensor device according to claim 1, wherein
the determination circuit includes a memory having memory areas for storing the power failure information, and
the controller is configured to, when the power failure occurs, simultaneously store information, which indicates that the power failure has occurred, in the memory areas, and to reset each memory area at a different timing in response to the return signal.

9. The sensor device according to claim 8, wherein
the controller is configured to transmit the return signal corresponding to at least one of the memory areas before storing the power failure information in the non-volatile memory.
